(19) United States
(12) Patent Application Publication
(10) Pub. No.: US 2026/0189184 A1
(43) Pub. Date: Jul. 2, 2026

(54) PV MODULE SHAPE FITTING FOR PV MODULE AUTO MAPPING

(71) Applicant: HANWHA SOLUTIONS CORPORATION, Seoul (KR)

(72) Inventor: Mudhafar HASSAN-ALI, Menlo Park, CA (US)

(73) Assignee: HANWHA SOLUTIONS CORPORATION, Seoul (KR)

(21) Appl. No.: 19/328,480

(22) Filed: Sep. 15, 2025

Related U.S. Application Data
(60) Provisional application No. 63/738,867, filed on Dec. 26, 2024.

(51) Int. Cl. H02S 50/00; G01S 5/02; G01S 5/14; G06F 3/04817; G06V 10/70

(52) U.S. Cl. CPC H02S 50/00; G01S 5/0242; G01S 5/145; G06F 3/04817; G06V 10/70

(57) ABSTRACT

An autonomous icon orientation method for accurately representing the photovoltaic (PV) modules in a PV array on a graphical user interface (GUI) of a computer system. The method including obtaining a map of the PV array, the map including distances between pairs of the PV modules in the PV array; clustering the PV modules into one or more neighborhoods based on the distances; determining a dominant angle of rotation for the PV modules in a corresponding neighborhood, of the one or more neighborhoods, based on angles between the distances between the PV modules in the corresponding neighborhood; and automatically rotating the icons in the corresponding neighborhood based on the determined dominant angle of rotation.

### CROSS-REFERENCE TO RELATED APPLICATIONS

This application claims priority under 35 U.S.C. § 119 to U.S. Provisional Application No. 63/738,867, filed on Dec. 26, 2024, the entire contents of which are incorporated herein by reference.

### TECHNICAL FIELD

Various example embodiments of the present disclosure relate to a PV (photovoltaic) module comprising MLPE (Module level power electronics) for measuring a distance and angle between adjacent modules, a system including the PV module, a method of automapping the PV module in a PV module map using the same; and a device configured to perform the method, and/or processing circuitry configured to perform the method. More specifically, the present disclosure is related to auto-orientating icons representing the PV modules in the PV module map.

### BACKGROUND

During the commissioning of new PV generator arrays and/or modification of existing arrays, PV module location mapping (e.g., array layout) is performed. The mapping (e.g., layout of the PV modules) is important for managing the individual PV module as a power generating source and as an asset that needs to be tracked periodically. Typically, the mapping is performed manually with some means related to assigning unique IDs (labeled with a QR (quick-response) code) to each PV module and manually monitoring the distances between identified PV modules. Therefore, a method of automatically determining the location, adjacency, and/or orientation of the individual PV modules would reduce installation, maintenance, and/or asset-tracking times and costs.

### SUMMARY

Some example embodiments provide autonomous icon orientation method for accurately representing the photovoltaic (PV) modules in a PV array on a graphical user interface (GUI) of a computer system; an electronic device configured to perform the method; and the computer system configured to display the GUI.

According to at least one example embodiment, a method of reorienting icons on a graphical user interface (GUI) of a computer system, the icons respectively representing photovoltaic (PV) modules in a PV array, comprises: obtaining a map of the PV array, the map including distances between pairs of the PV modules in the PV array; clustering the PV modules into one or more neighborhoods based on the distances; determining a dominant angle of rotation for the PV modules in a corresponding neighborhood, of the one or more neighborhoods, based on angles between the distances between the PV modules in the corresponding neighborhood; and automatically rotating the icons in the corresponding neighborhood based on the determined dominant angle of rotation.

According to at least one example embodiment, an electronic device includes processing circuitry; and a memory storing instructions. The instructions are configured to, when executed by the processing circuitry, cause the electronic device to generate a graphical user interface (GUI) of a map of a photovoltaic (PV) array, the GUI including icons respectively representing PV modules in the PV array, cluster the PV modules included in the map such that the PV modules are clustered into one or more neighborhoods based on distances between pairs of PV devices in the PV array, the PV devices each including one or more of the PV modules, determine a dominant angle of rotation for the PV modules a corresponding neighborhood, of the one or more neighborhoods, based on angles between the distances between the PV devices in the corresponding neighborhood, and automatically rotate the icons in the corresponding neighborhood based on the determined dominant angle of rotation.

According to at least one example embodiment, a computer system includes a display, processing circuitry, and memory including instructions. The instructions are configured to, when executed by the processing circuitry, cause the computer system to display a graphical user interface (GUI) of a map of a photovoltaic (PV) array on the display, the GUI including icons respectively representing PV modules in the PV array; and to orient the icons. The orienting the icons may include obtaining a map of the PV array, the map including distances between pairs of the PV modules in the PV array; clustering the PV modules into one or more neighborhoods based on the distances; determining a dominant angle of rotation for the PV modules in a corresponding neighborhood, of the one or more neighborhoods, based on angles between the distances between the PV modules in the corresponding neighborhood; and automatically rotating the icons in the corresponding neighborhood based on the determined dominant angle of rotation.

### BRIEF DESCRIPTION OF THE DRAWINGS

The example embodiments will be more fully understood from the detailed description given herein below and the accompanying drawings, wherein like elements are represented by like reference numerals, which are given by way of illustration only and thus are not limiting of this disclosure.

FIG. 1 illustrates an example of a photovoltaic (PV) generator according to at least one example embodiment;

FIG. 2 illustrates an example of an array of PV generators according to at least one example embodiment;

FIG. 3 illustrates a diagram for determining adjacency in an array of PV generators according to at least one example embodiment;

FIG. 4 illustrates a diagram for determining time of arrival (ToA) between an initiator and a responder according to at least one example embodiment;

FIG. 5 is an aerial image of an example layout for a PV array;

FIG. 6 is a flowchart illustrating a method according to at least one example embodiment

FIG. 7 is an example graph including location coordinates;

FIGS. 8A-8C and FIG. 9 are diagrams for illustrating icons in a PV array map based on the dominant angle; and

FIG. 10 is a block diagram schematically illustrating an example configuration of an electronic device 500.

### DETAILED DESCRIPTION

Various example embodiments will now be described more fully with reference to the accompanying drawings in which some example embodiments are shown, wherein numbers refer to like elements throughout the description of the figures.

Detailed illustrative example embodiments are disclosed herein. However, specific structural and functional details disclosed herein are merely representative for purposes of describing some example embodiments. The example embodiments may, however, be embodied in many alternate forms and should not be construed as limited to only the example embodiments set forth herein.

Accordingly, while example embodiments are capable of various modifications and alternative forms, the example embodiments are shown by way of example in the drawings and will be described herein in detail. Therefore, it should be understood that there is no intent to limit the example embodiments to the particular forms disclosed. On the contrary, the example embodiments are to cover all modifications, equivalents, and alternatives falling within the scope of this disclosure.

In addition, functional elements configured to perform certain roles and/or to perform functions, may be implemented and/or supported by processing circuitry such as, hardware, software, or a combination of hardware and software unless. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, an application-specific integrated circuit (ASIC), or any other device or devices capable of responding to and executing instructions in a defined manner, unless expressly indicated otherwise.

It will be appreciated that a number of example embodiments described herein may be used in combination. As discussed herein, the terminology “one or more” and “at least one” may be used interchangeably.

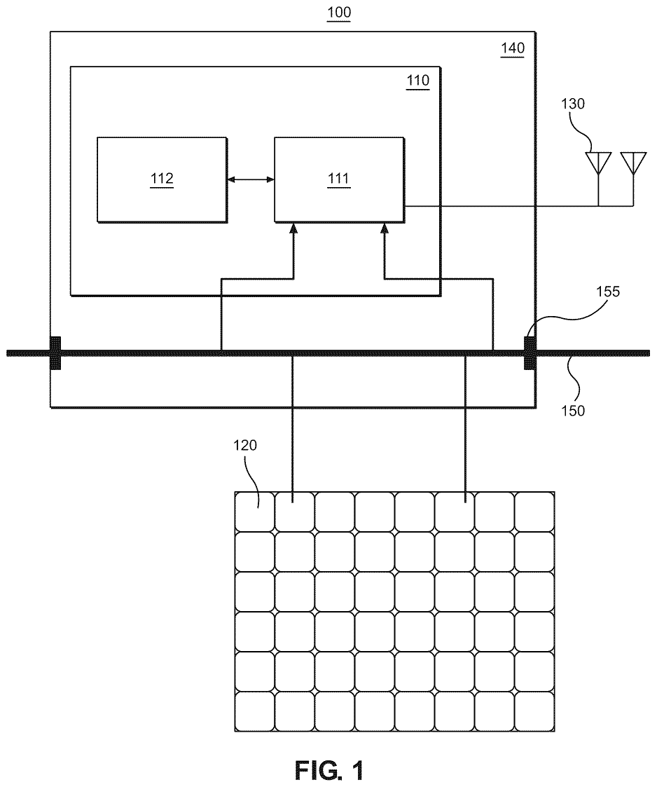

FIG. 1 illustrates an example of a photovoltaic (PV) generator (or PV device) 100. The PV generator 100 may include a Module Level Power Electronics (MLPE) 110, at least one PV module 120, a communication interface 130, and power line couplings 155, etc. The PV generator 100 may be configured to communicate with at least one external device 200, such as the gateway computer discussed below in further detail, but not limited thereto.

According to at least one example embodiment, the PV module 120 may include a plurality of PV cells sealed in, e.g., an environmentally protective laminate and/or a protective transparent material, etc. In the PV module 120, the PV cells may be connected in parallel and/or in series. The PV module 120 may further include at least a pair of conductive contacts, with one of the contacts configured to operate as an output for the power generated by the PV cells and the other contact configured to operate as an input to complete the circuit. The PV cells are configured to produce power (e.g., energy, current, etc.) in response to stimulation from radiation (e.g., solar radiation, etc.). For example, in at least one example, the PV cells are configured to operate as electron pumps in response to stimulation from photons. In at least one example embodiment, each of the PV cells may comprise at least one of a photovoltaic crystalline, polycrystalline, amorphous, and/or thin film semiconductor structure, but are not limited thereto.

In at least one example embodiment, a plurality of the PV module 120 may be included in a PV panel (not illustrated), and a plurality of panels may be included in a PV array (not illustrated).

According to at least one example embodiment, the MLPE 110 is configured to perform Maximum Power Point Tracking (MPPT) at the PV module level. For example, in at least one example embodiment, the MLPE 110 may be configured to control and/or adjust the operational current and/or voltage combinations of the PV module 120 (and/or a plurality of the PV module 120 in an array) to maximize power output based on, e.g., changes to the power output by the PV module 120, etc. For example, the MLPE 110 may be configured to monitor the current produced by the PV module 120 and to adjust the voltage in response to a change in current due to, e.g., time of day, weather conditions, shading and/or contaminate (e.g., dirt, soil, water, smog, and/or the like), etc., on the PV module 120, deterioration and/or damage to the PV module 120, etc., but the example embodiments are not limited thereto. Although the example illustrated in FIG. 1 shows the MLPE 110 monitoring a single PV module 120, the examples are not limited thereto, and, for example, in at least some example embodiments, the MLPE 110 may be configured to monitor and manage each of a plurality of PV modules in, e.g., a PV panel, at least a section of a PV array, and/or the PV array, etc.

The MLPE 110 may include processing circuitry 111 and memory 112, but is not limited thereto. The processing circuitry 111 may include hardware or hardware circuits including logic circuits; a hardware/software combination such as a processor executing software and/or firmware; or a combination thereof. For example, the processing circuity more specifically may include (and/or be included in) a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The memory 112 may include computer-readable program code (or “instructions”) stored in a computer-readable medium. The computer-readable program code may be provided to a variety of computers or processors of other data processing devices. The computer readable media may be, for example, a non-transitory computer readable media. The term “non-transitory,” as used herein, is a description of the medium itself (e.g., as tangible, and not a signal) as opposed to a limitation on data storage persistency (e.g., volatile memory vs. non-volatile memory, etc.). For example, the computer-readable recording medium may be any tangible medium that can store or include the program in or connected to an instruction execution system, equipment, or device, and may include a random access memory (RAM), a read only memory (ROM), and/or a non-volatile mass storage device, such as a disk drive, and/or a solid state drive, etc. The memory 112 may include, for example, computer readable instructions to be executed by the processing circuitry 111. In at least some example embodiments, such computer readable instructions may be loaded from a non-transitory computer-readable storage medium independent of the memory 112, such as using a drive mechanism (not illustrated), etc. For example, the memory 112 may include various special purpose program code including special purpose computer executable instructions which may cause the PV module 120 to perform one or more of the methods of the example embodiments.

Additionally, the processing circuitry 111 is configured to execute processes by retrieving the special purpose program code (e.g., the special purpose computer readable instructions) and data from the memory 112 to process them, thereby executing special purpose control and functions of the entire PV module 120. Once the special purpose program instructions are loaded into the processing circuitry 111, the processing circuitry 111 executes the special purpose program instructions, thereby transforming the processing circuitry 111 into a special purpose processor.

In at least one example embodiment the processing circuitry 111 and the memory 112 may be included, e.g., as a printed circuit board assembly (PCBA), a system-on-chip, and/or the like.

In at least one example embodiment, the MLPE 110 may further include an MLPE enclosure 140 protecting the processing circuitry 111, the memory 112, etc. The enclosure may include, for example, a plastic and/or metal.

The PV generator 100 further includes at least one communication interface 130. The communication interface 130 may be a wireless communication interface including one or more radio antenna. For example, the communication interface 130 may be configured to establish a wireless connection and to wirelessly communicate with another wireless communication interface. For example, the communication interface 130 may be configured to establish a least one of a Bluetooth connection, a Wireless Fidelity (WiFi) connection, a wireless mesh network connection, a cellular network connection, an ultra-wideband (UWB) connection, and/or the like. In at least one example embodiment, the communication interface 130 may further include at least one wired communication interface (e.g., an Ethernet connection, a power line communication (PLC) connection, etc.), and may be configured to establish a wired connection and to communicate with another wired communication interface over the wired connection and/or may be configured to communicate over a combination of wired and wireless connections.

In at least one example embodiment, the communication interface 130 may be configured to communicate with a gateway computer (e.g., a computer configured to monitor and/or instruct the MLPEs) and/or to a user's device (e.g., a smartphone, a computer, a monitoring device, etc.), e.g., through a direct connection (e.g., wired connection) and/or through a wireless network connection (e.g., the cellular network connection, the wireless mesh network, etc.). More specifically, in at least one example embodiment, a plurality of PV generators may be configured to establish a wireless network configure to connect the PV generators, and to connect the PV generators to an external device, such as the gateway computer, and/or a user's device.

The PV generator 100 further includes power line couplings 155 configured to be connected to a power line 150 and to transmit the power generated by the PV module 120 to the power line 150. In at least some example embodiments, the MLPE 110 may be configured to further communicate with neighboring MLPEs using, e.g., PLC, but is not limited thereto. For brevity and clarity, the figure illustrates only one PV module 120 associated with the MLPE 110, however the example embodiments are not limited thereto. For example, the MLPE 110 may be configured to monitor and control the operations of one or more PV modules 120 and/or one or more PV panels.

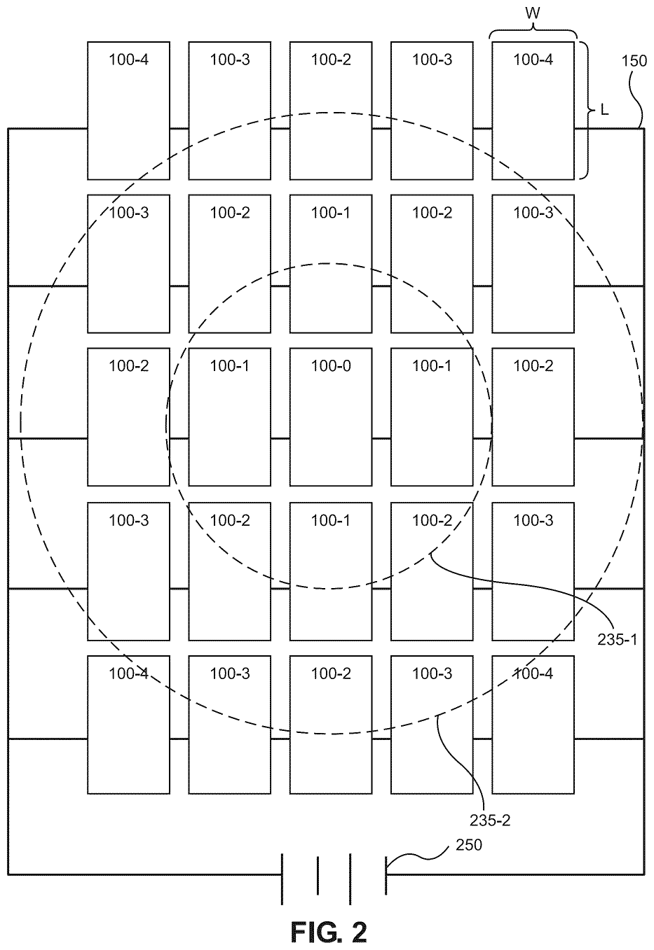

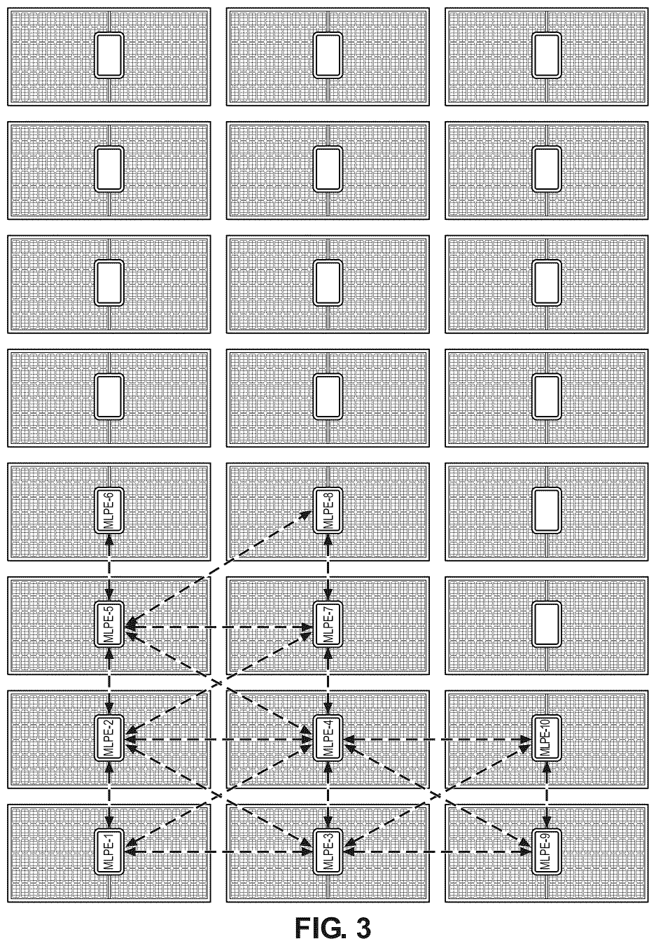

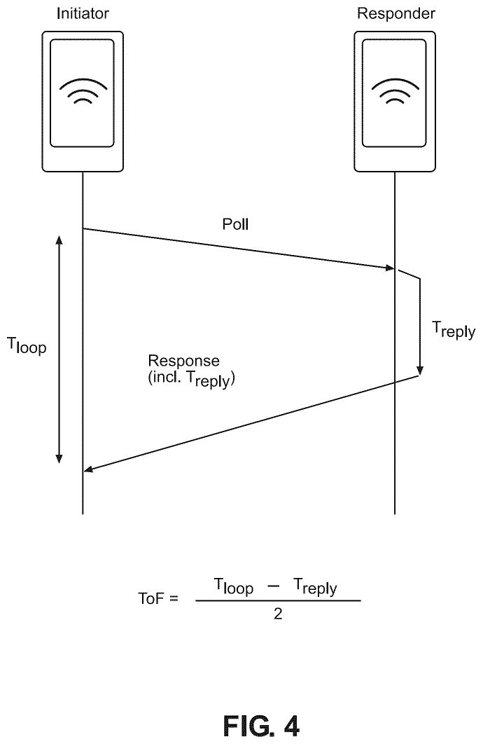

FIG. 2 illustrates an example of an array of PV generators 100-1 through 104-4; FIG. 3 illustrates a diagram for determining adjacency in an array of PV generators; and FIG. 4 illustrates a diagram for determining time of arrival (ToA) between an initiator and a responder according to at least one example embodiment. While FIGS. 2 and 3 illustrate an array of PV generators arranged in a two-dimensional grid for the sake of clarity, the example embodiments are not limited thereto, and for example, the arrangement of the array of PV generators may further include a third dimension (e.g., a vertical component).

According to at least one example embodiment, a PV generator (e.g., the PV generator 100 of FIG. 1) may be included in a plurality of PV generators 100-0, 101-1 through 101-4, 102-1 through 102-4, 103-1 through 103-112-3 and 101-4 through 104-4, but the example embodiments are not limited thereto. In at least one example embodiment, the plurality of PV generators 100-0 to 104-4 may be included in a grid configuration (e.g., including a plurality of columns and rows, as illustrated), and/or included in a honeycomb-like configuration (e.g., including a plurality of staggered rows or columns, not illustrated), but are not limited thereto. According to some example embodiments, the plurality of PV generators 100-0 to 104-4 may be arranged at a same vertical height (e.g., at the same elevation) and/or at different vertical heights (e.g., at different elevations). For example, the plurality of PV generators 100-0 to 104-4 may be on a flat surface, an incline, a mound, a structure (e.g., a house, a building, etc.), and/or the like.

Each of the plurality of the PV generators may be adjacent to a number of first-order adjacent PV generators (or “first-order neighbors”), wherein, the first-order adjacent PV generators represent the nearest neighboring PV generators to the referenced/selected PV generator. For example, a PV generator in the corner of the grid array (e.g., one of the PV generators 101-4 through 104-4) may include 2 (two) first-order adjacent PV generators, a PV generator in an edge of the grid array but not the corner (e.g., one of the PV generators 101-3 through 112-3) may include 3 (three) first-order adjacent PV generators, and a PV generator in the grid array but not in the corner or edge (e.g., PV generators 100-0 through 102-4) may include 4 (four) first-order adjacent PV generators. For example, using PV generator 100-0 as a reference, each of the PV generators in the grid array but not in the corner or edge includes a plurality of first-order adjacent PV generators 101-1 through 104-1. Alternatively, a PV generator in the corner of the honeycomb array may include 2 (two) first-order adjacent PV generators, a PV generator in an edge of the honeycomb array but not the corner may include 3 (three) to 5 (five) first-order adjacent PV generators, and an PV generator included in the grid array but not in the corner or edge may include 6 (six) first-order adjacent PV generators. Additionally, in at least some example embodiments, the PV generators may be arranged in a line array, and therefore a PV generator in the line array may include only one or two first-order adjacent PV generators. In at least some example embodiments, the array of PV generators may be divided into a plurality of sub-arrays or groups, and each group may be, for example, arranged as one or more of a grid, honeycomb, or line array. In other words, the array of the PV generators may include one or more a grid array, honeycomb array, line array, any combinations thereof, and/or the like.

In the array of PV generators, one or more subsets of the PV generators, such as a row or column of at least some of the PV generators may be connected in series, but the examples are not limited thereto. For example, in at least one example embodiment, each of the PV generator included in a row of the array of PV generators may be connected as a string or chain (e.g., in series) and each of the rows may be connected in parallel. Alternatively, in at least some example embodiments, the PV generators in the array (and/or components thereof) may be connected in parallel. For example, the array may be configured such that if one of the PV generators breaks-down, an interruption in the supply of energy by the other PV generators in the array does not occur. The array may be further connected to a power load 250, such as a power grid, a battery, and/or the like.

In at least some example embodiments, at least one of the MLPE may be configured to determine a location coordinate of the MLPE. For example, in at least some example embodiments, the MLPE may include a Global Positioning System (GPS) module configured to communicate with and to obtain an absolute position from, e.g., a GPS satellite. In at least some example embodiments, to reduce the cost per MLPE, GPS modules may be omitted in some or all of the MLPEs.

In at least some example embodiments, each of the MLPE included in the PV generator may be configured to establish communication (e.g., least one of a Bluetooth connection, a Wireless Fidelity (WiFi) connection, a wireless mesh network connection, a cellular network connection, an ultra-wide band (UWB) connection, and/or the like) with each of the corresponding first-order adjacent MLPEs. By establishing communication with the neighboring MLPEs, a neighborhood network may be formed, thereby enabling communication between MLPEs. Further, since each MLPE in the network enables communication between the neighboring MLPEs, the use of additional hardware facilitating communication with the MLPEs (e.g., router hubs, repeaters, etc.) may be reduced and/or omitted, thereby decreasing the cost and complexity of installing and maintaining the PV array. Each MLPE may be further configured to use the communication and/or the establishing of the network in order to obtain relative position data of itself and/or its respective PV generator. For example, in at least one example embodiment, a MLPE included in the PV generator 100-0 may be configured to transmit a ping signal 235-1 with a first intensity (e.g., a first signal strength, a first signal transmission power, etc.), and/or a plurality of ping signals (e.g., 235-1 through 235-n) with increasing intensities (e.g., increasing signal strengths, etc.). For the sake of clarity, the MLPEs are described as being at the center of the PV generators, but the example embodiments are not limited thereto, and for example, the MLPEs may be located at other positions within the PV generators, such as a corner of the PV generator, etc.

In at least one example embodiment, the MLPE may identify and/or define a neighboring MLPE that responds to the first ping 235-1 as a first-order adjacent MLPE. For example, in some example embodiments, the intensity of the first ping 235-1 may be set to a level wherein a signal strength of the first ping 235-1 is at or above a threshold (e.g., a first threshold, etc.) for the first-order adjacent MLPEs to respond, but the example embodiments are not limited thereto.

The intensity (e.g., the signal strength, signal transmission power, etc.) of the first ping 235-1 may be configured to accommodate the widths W and the lengths L of PV generators. For example, in a case wherein the PV generators are expected and/or designed to be spaced apart by a to-be determined (or preset) distance (“d”), and the length L of the PV generator may be between one to two times the width of the PV generator, the MLPE may set the intensity of the first ping 235-1 such that the intensity level of the signal at a distance of d+0.5 L is equal to the first-order threshold. However, this is only an example, and the example embodiments are not limited thereto. For example, in at least one example embodiment, the MLPE may set the intensity of the first ping 235-1 such that the intensity level of the signal at a distance of d+L is equal to the first-order threshold, thereby including the first-order adjacent PV generators and a sub-set of the second-order adjacent PV generators, etc.

For example, in these cases, as illustrated in FIG. 3, a corner MLPE (e.g., MLPE-1) is configured to establish one or more wireless connections with the orthogonal first-order adjacent MLPEs (e.g., MLPE-2 and MLPE-3) and the nearest diagonal second-order MLPEs (e.g., MLPE-4). Similarly, an MLPE at an edge of the grid array but not the corner (e.g., MLPE-3) is configured to establish one or more wireless connections with the orthogonal first-order adjacent MLPEs (e.g., MLPE-1, MLPE 4, and MLPE-9) with the nearest diagonal second-order MLPEs (e.g., MLPE-2, and MLPE 10); and an MLPE not at the edge or corner (e.g., MLPE-4) is configured to establish one or more wireless connections with the orthogonal first-order adjacent MLPEs (e.g., MLPE-2, MLPE-3, MLPE-7, and MLPE-10) and the nearest diagonal second-order MLPEs (e.g., MLPE-1, MLPE-5, MLPE-9, and MLPE-11), but the example embodiments are not limited thereto.

The MLPE may further be configured to receive and respond to pings from other MLPEs, and may be configured to establish one or more wireless connections with the one or more MLPEs transmitting the ping(s) (e.g., the initiating MLPEs). The initiating MLPE may be configured to poll one or more receiving MLPEs, e.g., the initiating MLPE may transmit a request to each of the receiving MLPEs, and each of the receiving MLPEs may provide a response, etc. The response may include an indicator of the time to reply (T_{reply}), and the distance between the initiating MLPE and the corresponding receiving MLPE may be determined based on a time of flight (ToF) calculation.

For example, as shown in FIG. 4, an initiator (e.g., an MLPE transmitting the ping) may provide a signal to (e.g., may poll) a responder (e.g., the MLPE responding to the ping) including a timestamp indicating when the signal was transmitted by the initiator, and the responder may be configured to provide a response to the signal including a timestamp indicating when the signal was transmitted by the responder. The response may further include a time-to-reply T_{reply} indicator of the time it took for the responder to respond to the signal, or in other words, the amount of time between when the responder received the signal from the initiator and when it transmitted its response. According to some example embodiments, the initiator may then calculate the distance between itself and the responder based on the calculated amount of time for the responder to receive the signal from the initiator (e.g., a ping transmission time) and/or the calculated amount of time for the initiator to receive the response from the responder (e.g., a ping response time), divided by the transmission speed of radio waves (e.g., approximately the speed of light). In some example embodiments, if the ping transmission time and the ping response time are not equal, an average of the ping transmission time and the ping response time may be taken and divided by the transmission speed of radio waves, or the initiator may repeat the polling operation, etc.

In at least some example embodiments, the initiator MLPE may include a plurality of transmitters, and the initiator MLPE may be configured to determine a relative angle and/or direction of the responder based on a difference in distance as determined based on the response received by the plurality of transmitters. For example, assuming that the initiator MLPE receives the response from the responder MLPE on two or more transmitters, the initiator MLPE may triangulate the relative position (e.g., the relative angle, the relative elevation, and/or the relative direction, etc.) of the responder MLPE based on the differences in the distances calculated of the same response received on the two or more transmitters.

In at least some example embodiments, the ToF information between the MLPEs may be collected by a gateway computer and/or a server included in or separate from the PV array, and, as described in further detail below, the server may be configured to determine a neighborhood map based on the determined distances and/or collected ToF information.

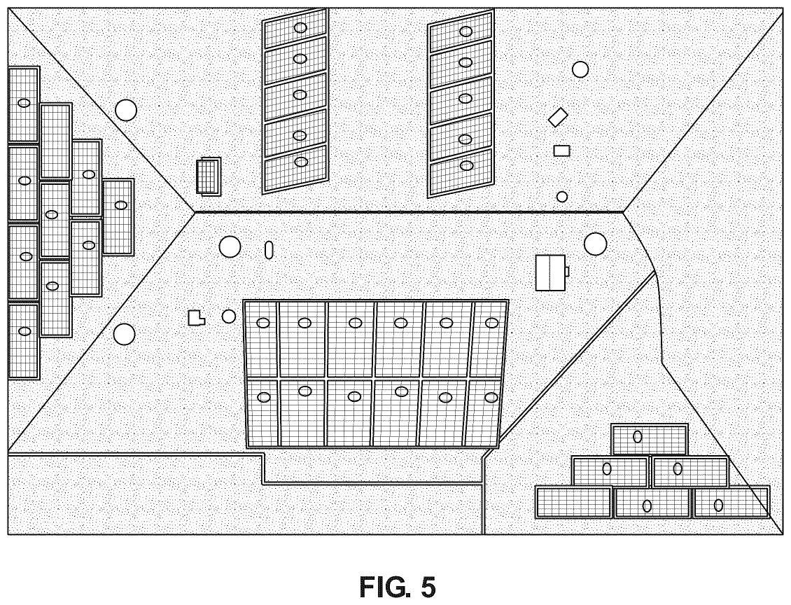

FIG. 5 is an aerial image of an example layout for a PV array according to at least one example embodiment.

As shown in FIG. 5, the layout of the PV array includes a plurality of groups, each group comprising a plurality of PV panels, with the groups spaced apart from each other. As the groups are comprised of neighboring PV panels, the groups may also be referred as neighborhoods.

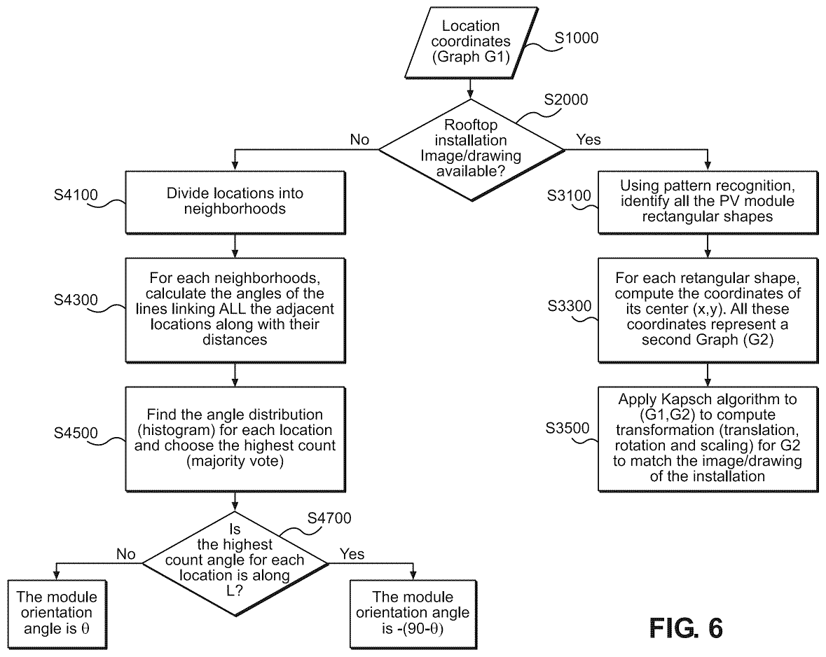

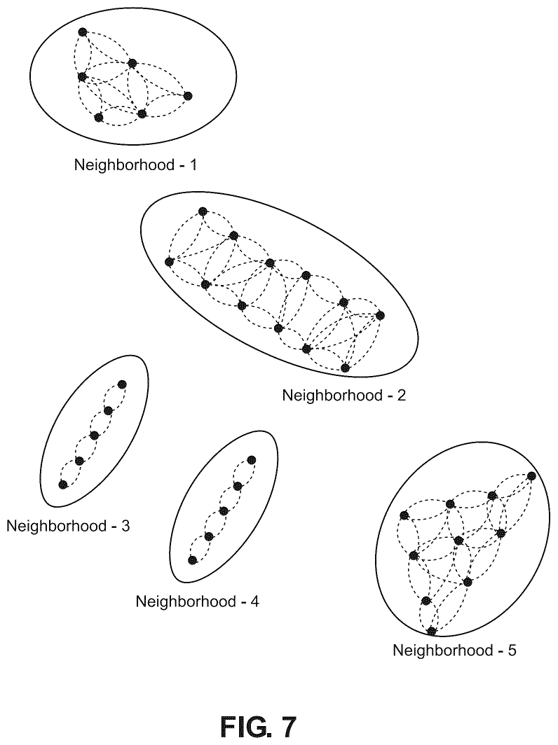

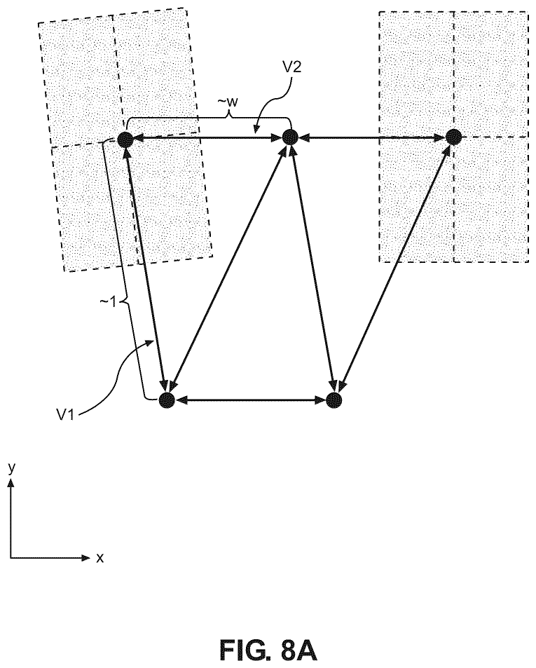

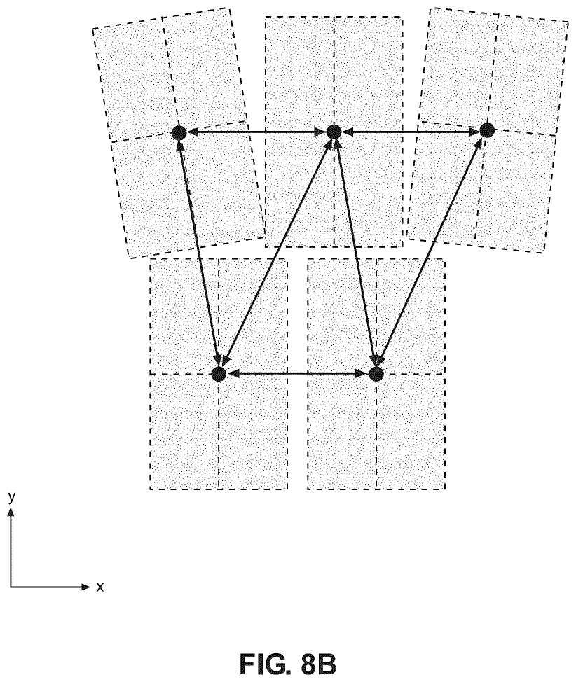

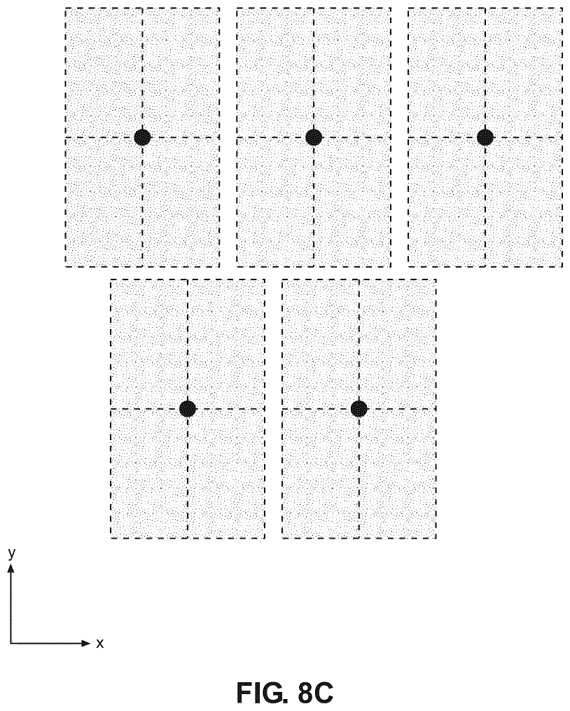

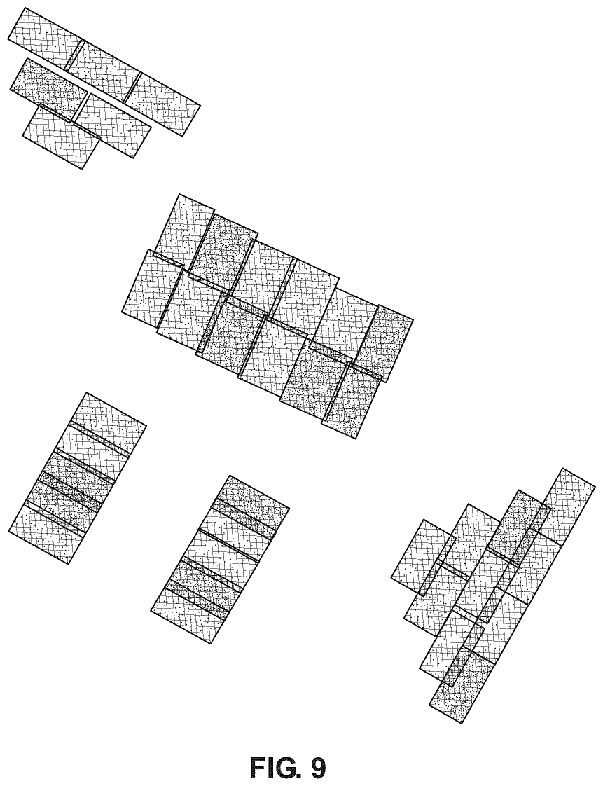

FIG. 6 is a flowchart illustrating a method according to at least one example embodiment. FIG. 7 is an example of the first graph G1 including the clustered location coordinates. FIGS. 8A-8C and FIG. 9 are diagrams illustrating an angle between line linking adjacent nodes. FIG. 9 is an illustration of an example PV map array after the operation of the method.

In at least some example embodiments, the method may be performed by processing circuitry included in at least one electronic device. For example, the processing circuitry may be included in the gateway computer, a server, and/or in a separate computer, such as a user's device, a laptop, etc., but the example embodiments are not limited thereto. For example, the processing circuitry may include a function as a service (FAAS) and/or cloud computing system, etc.

According to at least one example embodiment, a first graph G1 is generated (S1000) based on location coordinates received from the MLPEs performed by the electronic device. In at least one example embodiment, the location coordinates include the GPS location of at least one of the MLPEs and the relative positioning data of the MLPEs.

For example, the first graph G1 may include representations of the relative location data and may represent the locations of the PV panels by positioning nodes based on the relative location data. In at least one example embodiment, one of the nodes may be placed based on data representing the absolute position (e.g., obtained through GPS) of one of the MLPEs and the neighboring nodes may be placed based on data representing the relative position of the neighboring MLPEs. For example, in at least one example embodiment, each of the neighborhoods may include one or more absolute nodes representing MLPEs positioned using the absolute position data and a plurality of relative nodes positioned using the relative position data. More specifically, GPS may not be a viable candidate for high-resolution PV panel mapping because a typical horizontal accuracy for GPS (on the order of 3 to 10 meters) is too coarse relative to the physical size of the panels. In contrast, ultra-wideband (UWB) localization delivers sub-meter (e.g., between 0.1 to 0.3 meter) resolution. The order-of-magnitude improvement in measurement precision for UWB compared to GPS confines positional uncertainty to a small fraction of a panel, enabling meaningful spatial mapping and any downstream fine-grained positioning or alignment. In contrast, the error envelope for GPS would span multiple panels, which makes mapping and/or precise positioning not feasible for GPS.

Accordingly, since the relative position data has higher precision compared to the absolute position data, e.g., location data derived from UWB transmissions as discussed in connection with FIG. 4 has precision in the centimeter range, while GPS location data has precision in the meter range, a graph may be generated based on the relative position data, which is more accurate than the absolute position data obtained through GPS. The first graph G1 may further include lines connecting the nodes to each of the first-order neighboring nodes. In at least some example embodiments, the first graph G1 may further include data representing the calculated relative angles between the MLPEs, and/or the processing circuitry may be configured to determine the relative angles between the MLPEs based on the relative position data.

A graphical user interface (GUI) including and/or depicting a map of the PV array (or a “PV array map”) may be generated based on the first graph G1 by the electronic device. For example, the GUI may be generated such that an icon indicating the location of a PV module is placed on the map and a center point of the icon is on a respective one of the absolute and/or relatives nodes. The shape of the icon may be selected to match the shape of the PV panels. For example, in the case wherein the PV panels are rectangular with a length L and a width W, the icons may be rectangles with dimensions matching the L:W ratio of the PV panels. The GUI may further include a X-Y grid based on a vertical and horizontal orientation of GUI in a display for a two-dimensional representation of the PV array, or the GUI may include a X-Y-Z grid based on the vertical and horizontal orientation of the PV array and the height (e.g., altitude, elevation, etc.) of the PV array. The grid may be configured to be displayed or to be not displayed. For example, in at least some example embodiments, an option may be provided to the user to toggle on or off the grid being displayed.

According to at least some example embodiments, the availability of an image (e.g., a photograph, a satellite image, a drawing, a blueprint, a survey, and/or other graphical representation) of the PV array and/or the geographical area where the PV array is installed may be determined by the electronic device (S2000).

According to at least some example embodiments, in the case wherein an image of the PV array as installed (e.g., an image of the PV array installation) is available, the PV panels may be identified from the image using, e.g., pattern recognition operation performed by the electronic device (S3100). However, the example embodiments are not limited thereto, and for example, the pattern recognition may be performed by, e.g., a trained machine learning model, a trained neural network, a trained artificial intelligence, etc., or the electronic device may include the trained machine learning model, the trained neural network, the trained artificial intelligence, etc. For example, in at least some example embodiments, the image may be input into a pattern recognition module configured to identify the PV panels based on the L:W ratio.

Once the PV panels have been identified, the center and/or edge coordinates of each of the PV panels may be determined by the electronic device, and a second graph G2 may be generated based on the determined coordinates by the electronic device (S3300). As such, the second graph G2 may include nodes representing the coordinates of each of the PV panels as determined from the image.

Then, the second graphs G2 may be compared to the first graph G1 by the electronic device (S3500), and the icons in the GUI may be updated based on the comparison. For example, the Kabsch algorithm may be applied to the first and second graphs G1 and G2; and the icons in the GUI may undergo a transformation (e.g., one or more of a translation, rotation, scaling, and/or the like) based on the results of the Kabsch algorithm. Thereby, the layout of the PV panels and the neighborhoods may be represented in the GUI, wherein the PV panels are respectively represented by icons having the same (or substantially similar) shape, the same (or substantially similar) relative size, and the same (or substantially similar) relative orientation as the physical PV panels installed in the PV array, thus providing an improved and/or more accurate representation of the PV array installation. More specifically, the transformation of the representation of the PV array improves the functionality of the basic display function computing device, thereby improving the ability of the computing device to display information about the PV array and to interact with the user. The improved representation of the PV array installation may further allow for improved power generating performance tracking of the PV array by allowing the PV array operators to monitor the performance of the PV array over time and identify power generating issues due to the directionality of the PV generators of the PV array, environmental obstructions affecting a subset of the PV generators of the PV array, electrical issues in the PV array, improved determination of maintenance issues of the PV array, etc.

According to at least some example embodiments, in the case wherein an image of the PV array installation is not available, the nodes of the first Graph G1 may be clustered into one or more neighborhoods by the electronic device (S4100).

For example, as shown in FIG. 7, the first graph G1 may include the MLPEs clustered into neighborhoods (e.g., Neighborhood-1, Neighborhood-2, Neighborhood-3, Neighborhood-,4, Neighborhood-5, etc.).

In at least some example embodiments, the neighborhoods may be clustered based on the calculated distances between the PV panels in the PV array. For example, wherein a distance between a first group of PV panels and a second group of panels is greater than a desired and/or preset threshold and/or wherein a group includes rows and/or columns misaligned with the rows and/or columns of another group, than the groups may be clustered into different neighborhoods.

Referring to FIG. 6, after the neighborhoods are identified, the electronic device may determine, for each of the neighborhoods, the angles of the lines connecting all of the neighboring MLPEs in the neighborhood for each of the MLPEs (S4300). For example, in the case wherein the PV panels are rectangular, whether a first-order node is adjacent to a longer length L side or a shorter width W side may be determined based on the relative position data, wherein the distance from a first-order node adjacent to the shorter width W side (hereafter the wide-adjacent node) is shorter than the distance from a first-order node adjacent to the longer length L side (hereafter the length-adjacent node).

For example, as illustrated in FIGS. 8A-8C, the distances between the node and the neighboring nodes may comprise a first vector V1 (representing a distance in a first direction (e.g., the x-direction) between the node and the neighboring node) and a second vector V2 (representing a distance in a second direction (e.g., the y-direction)).

A plurality of angles θ may be determined based on the first and second vectors V1 and V2. For example, the plurality of angles θ may include a first angle θ1 (e.g., the angle between the first vector V1 and one of the X or Y axis in the X-Y grid) and a second angle θ2 (e.g., the angle between the second vector V2 and the other of the of X or Y axis) for each of the nodes, but the example embodiments are not limited thereto. Alternatively, in some example embodiments, one of the icons may be assigned as a reference icon, and an angle of the vector of the nodes and the first-order neighbors thereof may be determined based on the reference icon. However, the example embodiments are not limited thereto. For example, in at least some example embodiments, the angle may be based on a third angle (e.g., the angle) between first vector V1 and the second vector V2, and/or the difference of the third angle and an internal right angle in the icon (e.g., wherein the icon is a rectangle or square).

Referring back to FIG. 6, a distribution of the angles (θ) for the lines may be determined based on the neighborhood and a majority count may be determined from the distribution by the electronic device (S4500); and the angle with the majority count may be determined as the dominant angle. For example, in at least some example embodiments, the majority count may be based on (or determined as) a mode (e.g., most frequent count) of the distribution of angles (θ), a mean (e.g., an average) of the distribution of angles (θ), and/or any combination thereof.

According to at least some example embodiments, the electronic device compares the distance between the nodes and the neighboring nodes to the length and width of the icons representing the PV panels, and icons are rotated (or “re-oriented”) based on the majority angle (S4700).

For example, in the case wherein the icons are generated such that the longer length is oriented to be parallel to the second direction Y in the GUI, the PV panels are rectangles, and the majority angle (Θ) is a first angle θ1 or a second angle θ2, the icons may be rotated by Θ-90° or by Θ based on a determination of whether the majority angle Θ is along the length L of the PV panel. More specifically, the first and second vectors V1 and V2 may be compared to the length and width of the PV panel, and each of the icons may be respectively rotated by Θ-90° if the majority angle Θ is along the length L of the PV panel or by Θ if the majority angle Θ is along the width W of the PV panel. However, the example embodiments are not limited thereto. For example, in the case wherein the PV panels are a polygon, the majority angle Θ may be subtracted from a reference angle defined by the intersection of two (or more) lines extending from the sides, vertices, and/or corners of the panel and intersecting at the center thereof.

Thereby, as shown in FIG. 9, the orientation of the icons for each of the neighborhoods in a PV array map may be automatically adjusted (or “re-oriented”) based on the majority angle, such that each icon is orientated in the same (or a substantially similar) orientation as the other icons in the corresponding neighborhood.

Further, in at least one example embodiment, after the orientation of the icons are adjusted based on the majority angle θ, the position of at least a portion of the icons may be adjusted relative to the icons'first-order neighbors such that overlap between icons is minimized or reduced. For example, in some example embodiments, for each icon, the area of the overlap between the icon and each of the icon's first-order neighbors may be determined and compared to the total area of the icon, and the icon may be moved (e.g., repositioned), such that a total of the overlap areas, one or more of the overlap areas, and/or any combination thereof is reduced. In at least some example embodiments, the change in distance may also be considered, such that the change in distance does not exceed a threshold distance value and/or such that the repositioning of each icon is performed based on the overlap area and the change in distance. For example, each of the icons may be repositioned such that the change of distance (or position) and the area of overlap is reduced. In one example, a change in distance of an icon may increase an area of a first overlap area between a first-order neighbor and decrease an area of a second overlap area between the icon and another first-order neighbor. In this case, the icon may be repositioned such that the total of the first and second overlap areas is reduced for the least amount of change in distance. In these cases, the icon may be referred to as being re-positioned based on a “local minimum” between the change in position and the area(s) of overlap. In at least some example embodiments, the repositioning may be iterative, such that the icons are rearranged until both the change in distance and the total area overlap of the neighborhood is reduced to the local minimum of the areas of overlap and the change in distance.

The GUI with the adjusted icons may be displayed on a display of a computer system, e.g., the gateway computer and/or the user's device, etc.

Thereby, an accurate GUI representation of the layout of a PV array may be generated even when an image or diagram of the PV array is not available.

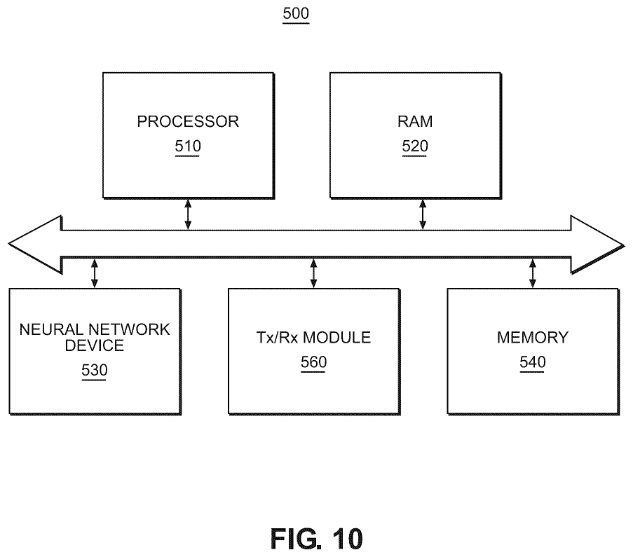

FIG. 10 is a block diagram schematically illustrating an example configuration of an electronic device 500. The electronic device 500 may be configured to perform the method described above with reference to FIG. 6. The electronic device 500 may be, for example, a gateway computer, and/or may be included in a server (e.g. a cloud computing server, a remote server, and/or the like).

The electronic device 500 may include a processor 510, a random access memory (RAM) 520, a neural network device 530, a memory 540, and a communication (transmission (Tx)/reception (Rx)) module 560. The electronic device 500 may further include an input/output module, a security module, a power control device, and the like.

The processor 510 controls the overall operation of the electronic device 500. The processor 510 may include a single processor core or a plurality of processor cores (e.g., Multi-Core). The processor 510 may process or execute programs and/or data stored in the memory 540. In some embodiments, the processor 510 may also control the function of the neural network device 530 by executing programs stored in the memory 540. The processor 510 may be implemented as a central processing unit (CPU), a graphics processing unit (GPU), an application processor (AP), or the like.

The RAM 520 is configured to temporarily store programs, data, or instructions. For example, programs and/or data stored in the memory 540 may be temporarily stored in the RAM 520 according to the control or boot code of the processor 510. The RAM 520 may be implemented as a memory such as dynamic RAM (DRAM), static RAM (SRAM), and/or the like.

The neural network device 530 is configured to perform an operation of the neural network based on the received input data and generate an information signal based on the execution result. The neural network may include, but is not limited to, one or more of a convolution neural network (CNN), a recurrent neural network (RNN), a feedforward neural network (FNN), a long short-term memory (LSTM), a stacked neural network (SNN), a state-space dynamic neural network (SSDNN), a deep belief networks (DBN), a restricted Boltzmann machine (RBM), and/or the like. The neural network device 530 may be a hardware accelerator itself dedicated to a neural network or a device including the same.

The neural network device 530 may be or include the pattern recognition module configured to identify the PV panels based on the L:W ratio. For example, the neural network device may include, for example, machine learning model such as linear regression, logistic regression, statistical clustering, Bayesian classification, decision trees, principal component analysis, and/or expert system, and/or machine learning model of ensemble techniques, etc., such as random forest. The machine learning model may be used to provide various services such as, for example, image classification service, user authentication service based on biometric information and/or biometric data, advanced driver assistance system (ADAS), voice assistant service, automatic speech recognition (ASR) service, and/or the like.

The memory 540 is a storage place for storing data and may store an operating system (OS), various programs, and various pieces of data. In at least one embodiment, the memory 540 may store intermediate results generated during the operation of the neural network device 530.

The memory 540 may be a DRAM, but is not limited thereto. The memory 540 may include at least one of a volatile memory and/or a nonvolatile memory. The nonvolatile memory includes read-only memory (ROM), programmable ROM (PROM), electrically programmable ROM (EPROM), electrically erasable and programmable ROM (EEPROM), flash memory, phase-change ROM (PROM), magnetic ROM (MROM), resistive ROM (RROM), ferroelectric ROM (FROM), and the like. The volatile memory includes dynamic RAM (DRAM), static RAM (SRAM), synchronous DRAM (SDRAM), phase-change RAM (PRAM), magnetic RAM (MRAM), resistive RAM (RRAM), and ferroelectric RAM (FeRAM). In at least one embodiment, the memory 540 may include at least one of a hard disk drive (HDD), a solid state drive (SSD), a compact flash (CF), a secure digital (SD), a micro secure digital (Micro-SD), a mini secure digital (Mini-SD), a memory stick, and/or the like.

The communication module 560 may include various wired or wireless interfaces configured to communicate with an external device. For example, the communication module 560 may include one or more interfaces for a wired local area network (LAN), a wireless local area network (WLAN) such as a wireless fidelity (Wi-Fi), a wireless personal area network (WPAN) such as Bluetooth, a wireless universal serial bus (USB), Zigbee, near field communication (NFC), radio-frequency identification (RFID), power line communication (PLC), and a communication interface capable of connecting to a mobile cellular network, such as 3rd generation (3G), 4th generation (4G), long term evolution (LTE), and/or the like.

As described above, an array of PV generators including a plurality of self-reporting MLPEs, enables the PV array to self-monitor the PV array and the adjust the orientation of icons representing the array, thereby simplifying the mapping of the array, and reducing installation, maintenance, and asset-tracking time and costs.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the preceding description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures, and techniques may be shown without unnecessary detail in order to avoid obscuring example embodiments.

As discussed herein, illustrative example embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing switches, hubs, routers, or other network elements, equipment and/or hardware. Such existing hardware may be processing circuitry or control circuitry.

Although a flow chart may describe the operations as a sequential process, many of the operations may be performed in parallel, concurrently, or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

Benefits, other advantages, and solutions to problems have been described above with regard to specific example embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

What is claimed is:

1. A method of reorienting icons on a graphical user interface (GUI) of a computer system, the icons respectively representing photovoltaic (PV) modules in a PV array, the method comprising:
obtaining a map of the PV array, the map including distances between pairs of the PV modules in the PV array;
clustering the PV modules into one or more neighborhoods based on the distances;
determining a dominant angle of rotation for the PV modules in a corresponding neighborhood, of the one or more neighborhoods, based on angles between the distances between the PV modules in the corresponding neighborhood; and
rotating the icons in the corresponding neighborhood based on the determined dominant angle of rotation.

2. The method of claim 1 further comprising:
reducing overlap between the icons by adjusting a center point of each of the icons after rotating the icons.

3. The method of claim 1, wherein the map of the PV array further includes a location coordinate for at least one of the PV modules.

4. The method of claim 1, wherein the determining the dominant angle includes
determining first distances between the PV modules and a first first-order neighbor;
determining second distances between the PV modules a second first-order neighbor;
determining whether the first distances and the second distances, respectively, correspond to a length or a width of the PV modules by comparing the first distances and the second distances to the length and the width of the PV modules; and
determining at least one of the angle between the first distances or the angle between the second distances.

5. The method of claim 1, wherein the map of the PV array further includes at least one of a first angle or a second angle for each of the PV modules, the first angle between first distances and one of an X axis or Y axis of the map, or a second angle between second distances and the other of the X axis or Y axis,
the first distances representing the distances between receivers in the PV modules and a transmitter in a first first-order neighbor, and
the second distances representing the distances between the receivers in the PV modules and a transmitter in a second first-order neighbor.

6. The method of claim 5, the determining the dominant angle includes determining which of the at least first or second angle is the dominant angle based on a mode of the angles in the corresponding neighborhoods.

7. The method of claim 6, wherein the rotating the icons includes rotating the icons by a mean-average of the angles corresponding to the dominant angle for each of the corresponding neighborhoods.

8. The method of claim 1, wherein the obtaining the map of the PV array includes determining the distances between pairs of PV modules based on a time-of-flight of ultra-wideband (UWB) signals between the pairs.

9. A electronic device including:
processing circuitry; and
a memory storing instructions, the instructions configured to, when executed by the processing circuitry, cause the electronic device to
generate a graphical user interface (GUI) of a map of a photovoltaic (PV) array, the GUI including icons respectively representing PV modules in the PV array,
cluster the PV modules included in the map such that the PV modules are clustered into one or more neighborhoods based on distances between pairs of PV devices in the PV array, the PV devices each including one or more of the PV modules,
determine a dominant angle of rotation for the PV modules a corresponding neighborhood, of the one or more neighborhoods, based on angles between the distances between the PV devices in the corresponding neighborhood, and
rotate the icons in the corresponding neighborhood based on the determined dominant angle of rotation.

10. The electronic device of claim 9, wherein the electronic device is further configured to
receive an image of a PV array installation;
identify the PV modules from the image using pattern recognition;
generate a graph based on a center point and angle of the identified PV modules; and
transform the icons of the GUI based on the graph.

11. The electronic device of claim 10, wherein the transform the icons of the GUI includes at least one of translation, rotation, or scaling the icons.

12. The electronic device of claim 9, wherein the electronic device is further configured to:
reduce overlap between the icons by adjusting a center point of each of the icons.

13. The electronic device of claim 9, wherein the map of the PV array further includes a location coordinate for at least one of the PV modules.

14. The electronic device of claim 9, wherein the map of the PV array further includes at least one of a first angle or a second angle for each of the PV modules, the first angle between first distances and one of an X axis or Y axis of the map, or a second angle between second distances and the other of the X axis or Y axis,
the first distances representing the distances between receivers in the PV modules and a transmitter in a first first-order neighbor, and
the second distances representing the distances between the receivers in the PV modules and a transmitter in a second first-order neighbor.

15. The electronic device of claim 14, wherein the dominant angle includes determining which of the at least first or second angle is the dominant angle based on a mode of the angles in the corresponding neighborhoods.

16. The electronic device of claim 9, wherein the electronic device is further configured to:
determine the distances between pairs of PV modules based on a time-of-flight of ultra-wideband signals (UWB) between the pairs.

17. The electronic device of claim 9, wherein the electronic device is further configured to:
determine a location of at least one of the PV devices using Global Position System (GPS); and
determine a relative position of at least a portion of a remainder of the PV modules based on a time-of-flight (ToF) of a signal transmitted between the at least one PV device and the portion of the remainder of PV devices.
